(19) United States
(12) Patent Application Publication
(10) Pub. No.: US 2007/0131909 A1
(43) Pub. Date: Jun. 14, 2007

(54) Process for the production of synthesis gas from carbon-containing material and electrical energy

(76) Inventors: Alexandre Rojey, Rucil Malmaison (FR); Edouard Freund, Rucil-Malmaison (FR); Nicolas Boudet, Lyon (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/592,324

(22) Filed: Nov. 3, 2006

(30) Foreign Application Priority Data
Nov. 4, 2005 (FR) 05/11.279

(51) Int. Cl. C01B 3/38; C25C 1/02

(52) U.S. Cl. 252/373; 205/628

(57) ABSTRACT

The invention relates to a process for the production of a synthesis gas SG 1. Process for the production of a synthesis gas SG that has an H2/CO ratio of between 1.9 and 2.3 starting from a carbon-containing material that is relatively low in hydrogen, water and electrical energy, in which: Electrolysis of the water is carried out to produce, on the one hand, oxygen, and, on the other hand, hydrogen, A CF current that comprises at least the majority of the carbon contained in the carbon-containing material CF is subjected to a partial oxidation POX with essentially pure oxygen produced by electrolysis, At least a portion of the hydrogen that is produced by electrolysis is added to the CF current upstream and/or downstream from the partial oxidation POX, in such an amount that the H2/CO ratio of the final synthesis gas SG is between 1.9 and 2.3, the carbon-containing material being dried upstream from the POX so that the O2/H2 molar ratio of the POX-supplied oxygen to the added hydrogen is between 0.45 and 0.55.

### FIELD OF THE INVENTION

The object of the invention is a process for the production of synthesis gas starting from a heavy carbon-containing material such as carbon or lignite, heavy petroleum residues or biomass, in particular wood or vegetable waste. The synthesis gas that is obtained makes it possible to produce, according to various known processes for chemical conversion, paraffinic or olefinic hydrocarbons, which are bases of high-quality liquid fuels (diesel fraction with a high cetane number, kerosene, etc. . . . ) or petrochemical bases. It can also be used for producing oxygenated compounds, for example methanol or dimethyl ether.

### PRIOR ART

Several processes for the production of synthesis gas starting from carbon-containing materials, in particular vaporeforming, partial oxidation and the autothermal process, are already known.

The vaporeforming (known under the initials SMR, which comes from the English “steam methane reforming,” which means “reforming of methane with vapor”) consists of reacting the feedstock, typically a natural gas or light hydrocarbon, to a catalyst in the presence of water vapor to obtain a synthesis gas that primarily contains, in addition to water vapor, a mixture of carbon oxide and hydrogen oxide. This operation is endothermal. It is typically carried out by circulating the feedstock, diluted with water vapor, in tubes filled with catalyst (generally a catalyst with nickel, for example comprising 6 to 25% by weight of nickel deposited on a substrate that primarily comprises alumina or a mixture of alumina and one or more other refractory compounds). The tubes are typically heated by radiation in tubular furnaces. This process is well suited to gaseous feedstocks, in particular to natural gas, but is incompatible with heavy carbon-containing feedstocks that contain impurities such as carbon, petroleum residues or biomass (wood or other ligno-cellulose compounds, vegetable waste, . . . ).

By combustion under sub-stoichiometric conditions, partial oxidation or gasification by partial oxidation (known under the abbreviation POX that comes from the English “partial oxidation,” which means partial oxidation) consists in forming a mixture at high temperature, generally between 1000° C. and 1600° C., of carbon-containing material, on the one hand, and air or oxygen on the other hand, to oxidize the carbon-containing material and to obtain a synthesis gas. When a synthesis gas without nitrogen is sought, this process uses oxygen, produced by air distillation according to the conventional techniques. The POX is compatible with all forms of carbon-containing feedstocks, including heavy feedstocks.

The autothermal process (known under the initials ATR, which comes from the English “autothermal reformer,” which means auto-thermal reformer) carries out a partial oxidation immediately followed by a catalytic vaporeforming under adiabatic conditions at high temperature, for example in the output temperature range: 900° C.-1000° C. This process produces a combination in series of the two preceding reaction modes. It consumes less oxygen than the POX process but requires a catalytic bed. Like vaporeforming, it can be used only with light feedstocks and is not compatible with heavy carbon-containing materials such as carbon, petroleum residues or the biomass such as wood or vegetable waste.

Finally, the only known process for the production of synthesis gas that is well suited to heavy carbon-containing materials that are typically loaded with heteroatoms, such as metals (Ni, V) and/or N, O, S, is the partial oxidation, or POX. This POX process, typically carried out with oxygen and under pressure, makes it possible to easily produce synthesis gases that are suitable for desired syntheses downstream.

The desired H2/CO ratio can vary according to the desired synthesis and/or the catalyst that is used. This ratio is different, for example, according to whether a catalyst with iron or alternatively with cobalt is used during the synthesis of the waxes for the production of diesel bases. This H2/CO ratio can be easily modified by known processes of the prior art; when it is too low, it is possible to increase it by converting the CO to vapor (“water gas shift” in English), which makes it possible to reduce the CO content and to increase the hydrogen content by carrying out the reaction: CO+H2O=CO2+H2. It was also proposed to add the external hydrogen that was produced by vaporeforming. If the H2/CO ratio proved too high for a given synthesis, an elimination of excess hydrogen, separated by cryogenics or gaseous permeation, could be carried out.

The prior art therefore discloses a POX process that makes it possible to gasify difficult feedstocks, such as heavy carbon-containing materials, typically loaded with impurities, to obtain a synthesis gas with suitable composition. There is still a need to improve the performance levels of the POX process, applied to heavy carbon-containing materials, from the standpoint of the overall energy efficiency, so as to better upgrade these heavy carbon-containing materials. There is also a need for finding a new energy system that upgrades these carbon-containing materials that are less dependent on petroleum or natural gas and is compatible with renewable energies.

It is also desired to increase the “carbon yield,” i.e., the amount of synthesis gas that can be produced starting from a given quantity of heavy carbon-containing material. Finally, it is also important to find a new energy system that upgrades these carbon-containing materials and that sends less CO2 back into the atmosphere.

The object of the process according to the invention is to propose a process that meets at least one and at least in part all of these requirements in the field of new energy technologies.

The invention also makes it possible to attain this object with a reliable and simple installation, which does not add complexity or absence of reliability to a POX gasification of heavy carbon-containing materials that is inherently a difficult technology.

### SUMMARY DEFINITION OF THE INVENTION

To attain the above-mentioned objects, the process according to the invention uses, combined with a partial oxidation operation with oxygen from the carbon-containing material, an electrolysis operation making it possible to produce oxygen and hydrogen from water. The oxygen is used for the partial oxidation with oxygen of the carbon-containing material. The hydrogen is used as an additional gas for modifying and adapting the H2/CO ratio of the synthesis gas, in particular so that this ratio can be close to 2.1 and suitable for a transformation of the synthesis gas into hydrocarbons by chemical synthesis according to various processes that are known for which such a ratio is desired. The invention makes it possible, thanks to a determined drying of the carbon-containing material, to use as well as possible the oxygen and the hydrogen that are produced by the electrolyzer.

The POX gasification operations, on the one hand, and the electrolysis operation, on the other hand, are conventional in themselves and any known techniques can be used.

The invention therefore is not tied to a particular technique of electrolysis or gasification but to the synergy provided by the combination of these techniques when it is applied to the POX gasification of heavy carbon-containing materials, in particular for the production of synthesis gas with a relatively high H2/CO ratio: the electrolysis provides the oxygen that is necessary to the POX but also additional hydrogen, making it possible to increase the H2/CO ratio. It is therefore possible to reduce or even eliminate the operation for conversion of CO to vapor (water gas shift), which is very favorable from the standpoint of the amount of CO2 produced and therefore typically of gas emissions with a greenhouse effect. The reduction or elimination of the conversion from CO to CO2 further results directly in increasing the carbon yield of the energy system.

Finally, the electrolysis techniques are relatively simple and reliable and do not provide the degree of additional complexity or the lack of reliability. On the contrary, they make it possible to provide oxygen and additional hydrogen simultaneously in the same piece of equipment rather than with two separate units: an air distillation unit, on the one hand, and a CO or vaporeforming conversion unit, on the other hand.

The necessary electricity may be provided by a nuclear plant, without CO2 emission. It can also be a renewable energy (of solar origin, in particular photovoltaic, or eolian, or hydroelectric) and does not require fossil energy.

### DETAILED DESCRIPTION OF THE INVENTION

Below, the expressions “partial combustion,” “gasification,” “partial oxidation,” or “POX” will be used equally. Combustion can designate a partial or total combustion.

The invention proposes a process for the production of a synthesis gas SG that has an H2/CO ratio of between 1.9 and 2.3 starting from a carbon-containing material that is relatively low in hydrogen, water and electrical energy, in which:
An electrolysis of the water is carried out for producing, on the one hand, oxygen, and, on the other hand, hydrogen;
A current CF that comprises at least the majority of the carbon that is contained in the carbon-containing material CF is subject to a partial oxidation POX with oxygen that is essentially pure and is produced by electrolysis,
At least a portion of the hydrogen that is produced by electrolysis is added to the current CF upstream and/or downstream from the partial oxidation POX in such a quantity that the H2/CO ratio of the final synthesis gas SG is between 1.9 and 2.3,
   whereby the process upstream from the POX comprises a stage DRY for drying said carbon-containing material, whereby the degree of drying during the drying stage is determined so that the electrolysis oxygen that is used in the POX stage and the added electrolysis hydrogen are in an O2/H2 molar ratio of between 0.45 and 0.55.

Thus, the electrolysis provides both oxygen for gasification and input hydrogen for reaching a suitable H2/CO ratio. The degree of drying is suitable such that the needs of the process correspond essentially to the production of the electrolyzer (O2/H2=2).

The electrical energy can be produced by various sources. It can be of nuclear or renewable origin (of solar, hydroelectric or eolian origin) and therefore typically does not emit CO2 or other gases with greenhouse effect.

The carbon-containing material can comprise primarily (at more than 50% by weight in considering only the carbon balance) or totally the vegetable biomass. It can also comprise primarily or totally carbon or lignite. Finally, the carbon material can comprise primarily a petroleum residue that consists for the most part (more than 50% by weight) of hydrocarbons boiling above 550° C.

According to a preferred variant of the invention, the process comprises, upstream from the POX, a stage DRY for drying the carbon-containing material that is suitable for using the production of the electrolyzer fully. The degree of drying during the drying stage advantageously can be determined so that the electrolysis oxygen that is necessary to the POX stage and the added electrolysis hydrogen are in an O2/H2 molar ratio of between 0.45 and 0.55 and preferably essentially equal to 0.5. In the above-mentioned cases, the respective productions of oxygen and hydrogen are nearly balanced or are balanced: essentially all of the hydrogen and all of the oxygen produced by the electrolyzer are used. The suitable drying rate depends on the raw material. After drying, the degree of moisture of the carbon-containing material is often between 8% and 35%, in particular between 12% and 28%, typically between 15% and 25% by weight of water. The stage DRY for drying the carbon-containing material can advantageously use the heat energy transferred directly or indirectly from the effluent of the POX by recovery of heat in this effluent. This energy is actually available in abundant amounts.

The water content of the material supplied to the gasifier actually plays a role in the necessary yields and O2/H2 ratio. Actually, the total water content plays a role in the importance of heat vaporeforming reactions and more generally the H2/CO/CO2/H2O balance. The moisture also plays a role in the amount of oxygen necessary to the constant total water quantity because of the necessity of vaporizing the residual water. Finally, the use of a limited drying leads to gains in the energy level and to that of investments relative to an intense drying. Conversely, if a very moist raw material is not dried, the needs of combustion, therefore of O2, are increased more than necessary, which requires a very high electrical power for the electrolyzer and leads to excess hydrogen.

Optionally, upstream from the POX, the process comprises a stage PYR for pyrolysis of said carbon-containing material. This stage can be a “flash pyrolysis” (quick pyrolysis) that is carried out at a temperature that is typically between 500° C. and 650° C. with a dwell time of the gases of between 0.1 and 2 seconds, preferably between 0.3 and 1.5 seconds. It is also possible to use pyrolysis at a more moderate temperature, for example between 380° C. and 450° C. The technologies of pyrolysis that can be used comprise heating in a horizontal reactor with a single screw, or double screw, heated by a circulation of sand or steel balls. It is also possible to inject the carbon-containing material into a fluidized bed, for example a fluidized bed that circulates heated sand by combustion of the residual carbon-containing portions. The pyrolysis typically provides, after condensation, an organic phase, an aqueous phase, a carbon-containing solid phase and residual gas (primarily CO2, CO, hydrocarbons of C1 to C4). The pyrolysis makes it possible to send to the POX only a fraction of the organic liquid produced.

The process according to the invention optionally comprises, upstream from the POX, the stage DRY (drying) followed by the stage PYR (pyrolysis), and the current CF comprising at least a fraction of the effluents of the stage PYR, for example, organic liquid fractions and/or the solid fraction that contains carbon. The current CF can also comprise all of the liquid fractions and optionally gaseous fractions produced in the pyrolysis stage.

The partial oxidation with oxygen POX can be implemented according to any of the known technologies, typically with (a) burner(s) and mixing chamber. The wall of the oxidation chamber is typically coated with refractory materials and optionally cooled with water. The partial oxidation technologies are described in particular in the reference document: “P. Leprince, The Refining of Petroleum, Volume 3 Processes of Transformation, TECHNIP Editions, Paris, pages 494-499.”

The current CF supplied to the POX can comprise water vapor generated during the cooling of the effluents of this POX.

Electrolysis is a well-known technique, described in numerous physics or chemistry manuals. It is possible to use various electrolytes, for example a solution with 25% by weight of potassium hydroxide. The electrolysis can be carried out under a relatively high pressure Pe of between 0.5 and 3.5 MPa, preferably between 0.5 and 2 MPa. It then is possible advantageously to supply the POX directly at an essentially identical pressure Pₚₒₓ that confirms 0<Pe−Pₚₒₓ<0.25 MPa. The operating pressure of the electrolyzer generally actually determines the pressure at which the POX is produced, typically slightly less, so as not to call for oxygen and hydrogen compressors.

As an alternative, the electrolysis can be carried out under a lower pressure Pe, for example between 0.1 and 0.5 MPa, and even close to the atmospheric pressure of between, for example, 0.10 and 0.15 MPa.

The composition of the synthesis gas that is obtained can thus be adjusted to supply a synthesis unit that uses, for example, a catalyst with cobalt. In this case, long-chain products (primarily paraffins) that form solid waxes under ambient conditions of temperature and pressure are obtained. These waxes can be converted into lighter fractions, comprising middle distillates and kerosene, by using a hydrocracking process. At least one fraction or all of the hydrogen that is used for this hydrocracking operation can be obtained from the electrolysis stage.

### BRIEF DESCRIPTION OF DRAWING

FIG. 1 is a block flowsheet of an installation for the implementation of the process according to the invention.

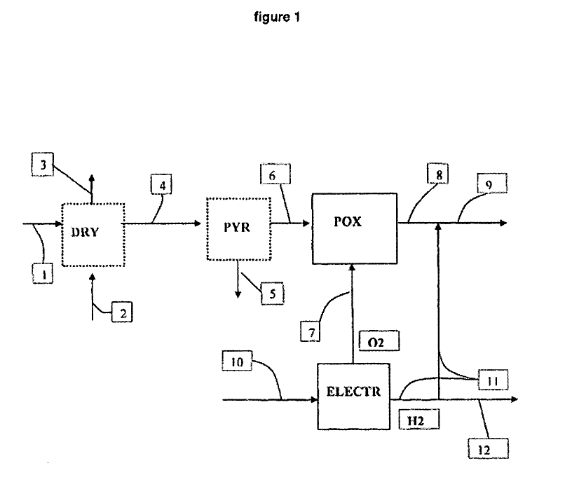

### DESCRIPTION OF FIG. 1

Wood in the form of small chips (for example of several mm), having a degree of moisture of 40% by weight, supplies via the line 1 a drying apparatus DRY, for example a drying apparatus with a carpet conveyor or else a fluidized bed. Warm air is supplied via the line 2, and moist air is extracted via the line 3. The wood that is dried at a degree of moisture of 20% by weight supplies a pyrolysis unit PYR (optional) at 400° C. using, for example, heating in a double-jacket cylinder and circulation of a thermal fluid (molten salt, fluidized bed, or pressurized smoke). After cooling to 100° C., a portion of the liquid that is produced, or bio-oil (biological oil) as well as the residual gas are evacuated via the line 5 for a treatment downstream. Another portion of the bio-oil is mixed with the carbon-rich solid portion, then pumped in the form of slurry (suspension) from the atmospheric pressure to the pressure of 2 MPa to supply the POX unit via the line 6. The POX unit produces a partial oxidation at 1400° C. with the oxygen that is supplied via the line 7. The oxygen can optionally be diluted with water vapor. The effluent of the POX unit that circulates in the line 8 is cooled by means that are not shown (heat exchanger or direct cooling by mixing with water or another cold fluid). This effluent is mixed with the hydrogen that is supplied via the line 11 to form a synthesis gas that has an H2/CO ratio of 2.1 circulating in the line 9.

The oxygen that circulates in the line 7 and the hydrogen that circulates in the line 11 are produced by an electrolyzer ELECTR starting from water supplied via the line 10. Excess hydrogen, if it exists, is evacuated via the line 12.

### EXAMPLES

### Example 1 for Comparison

A synthesis gas production unit for the implementation of the process according to the invention treats wood chips. This unit is in accordance with the diagram of FIG. 1 but without a drying unit DRY or a pyrolysis unit PYR.

The wood flow rate is 30,000 kg/h, including 18,000 kg/h of dry material. The wood is sent directly to the POX unit, also supplied by 14,603 kg/h of oxygen. The effluent at the outlet of the POX is a synthesis gas that has a molar ratio H2/CO=0.79 with a flow rate of 44,603 kg/h, a temperature of 1400° C., and under a pressure of 2.9 MPa. This gas is cooled then mixed at 1,011 kg/h of hydrogen to produce 45,614 kg/h of synthesis gas, including 21,530 kg/h of the H2+CO mixture with a molar ratio H2/CO =2.1.

The electrolyzer is supplied by 16,443 kg/h of water and consumes an electrical power of 92 MW. It produces 14,603 kg/h of oxygen, flow rate integrally consumed by the POX unit, and 1,840 kg/h of hydrogen, of which 1,011 is added to the synthesis gas and 829 kg/h is produced in excess.

The molar compositions of the POX output synthesis gas and the final synthesis gas (after the addition of hydrogen) are as follows:

TABLE 1

| Molar % of the Composition | POX Output | Final |
|---|---|---|
| H2 | 15.1 | 32.0 |
| CO | 19.0 | 15.2 |
| CO2 | 17.6 | 14.1 |
| H2O | 48.3 | 38.7 |

### Example 2 According to the Invention

The gasification of the same quantity of wood as in Example 1 is carried out, but a previous drying of this wood is carried out. The flow rate of the wood at the output of the drying unit DRY is 22,500 kg/h, including 18,000 kg/h of dry material. The wood is then sent directly to the POX unit, supplied also by 11,914 kg/h of oxygen. The effluent at the output of the POX is a synthesis gas that has a molar ratio H2/CO=0.67 with a flow rate of 34,414 kg/h, a temperature of 1400° C., and under a pressure of 2.9 MPa. This gas is cooled and then mixed with 1,482 kg/h of hydrogen to produce 35,896 kg/h of synthesis gas including 24,409 kg/h of the H2+CO mixture with a molar ratio of H2/CO=2.1.

The electrolyzer is supplied by 13,415 kg/h of water and consumes an electrical power of 75 MW. It produces 11,914 kg/h of oxygen, flow rate integrally consumed by the POX unit, and 1,501 kg/h of hydrogen, of which 1,482 kg/h is added to the synthesis gas and 19 kg/h is produced in excess.

The molar compositions of the POX output synthesis gas and the final synthesis gas (after addition of hydrogen) are as follows:

TABLE 2

| Molar % of the Composition | POX Output | Final |
|---|---|---|
| H2 | 21.4 | 46.1 |
| CO | 32.0 | 21.9 |
| CO2 | 14.1 | 9.6 |
| H2O | 32.5 | 22.4 |

It is seen that the performance levels obtained in Example 2 are considerably higher than those of Example 1: The electrical power that is consumed is much lower whereas the amount of synthesis gas produced is higher. This results from the effect that is obtained by the adjustment of the degree of drying, essentially making it possible to adapt the respective needs of oxygen and hydrogen then corresponding essentially to the production of the electrolyzer (excess hydrogen essentially zero). It was actually found that an increase of the degree of drying led to increasing the added H2/O2 ratio that is necessary to the POX. It is therefore possible to adjust the degree of drying to adapt it to the production of the electrolyzer (O2/H2=0.5).

The preceding examples can be repeated with similar success by substituting the generically or specifically described reactants and/or operating conditions of this invention for those used in the preceding examples.

The entire disclosures of all applications, patents and publications, cited herein and of corresponding French application No. 05/11.279, filed Nov. 4, 2005 are incorporated by reference herein.

From the foregoing description, one skilled in the art can easily ascertain the essential characteristics of this invention and, without departing from the spirit and scope thereof, can make various changes and modifications of the invention to adapt it to various usages and conditions.

1. A process for the production of a synthesis gas (SG) that has an H2/CO ratio of between 1.9 and 2.3 starting from a carbon-containing material is relatively low in hydrogen; water; and electrical energy, wherein:
Electrolysis of the water is carried out to produce oxygen and, hydrogen,
A flow (CF) that comprises at least the majority of carbon contained in the carbon-containing material is subjected to a partial oxidation (POX) with essentially pure oxygen produced by said electrolysis,
At least a portion of the hydrogen that is produced by electrolysis is added to the flow (CF) upstream and/or downstream from the partial oxidation POX, in such an amount that the H2/CO ratio of the final synthesis gas (SG) is between 1.9 and 2.3,
the process comprising, upstream from the POX, a drying stage (DRY) for drying said carbon-containing material, whereby the degree of drying during the drying stage is adjusted so that the electrolysis oxygen used in the POX stage and the added electrolysis hydrogen are in an O2/H2 molar ratio of between 0.45 and 0.55.

2. A process according to claim 1, wherein said O2/H2 molar ratio is essentially equal to 0.5.

3. A process according to claim 1, in wherein said carbon-containing material comprises primarily or totally vegetable biomass.

4. A process according to claim 1, in wherein said carbon-containing material comprises primarily or totally carbon or lignite.

5. A process according to claim 1, wherein said carbon-containing material comprises primarily a petroleum residue of a majority of hydrocarbons boiling above 550° C.

6. A process according to claim 1, wherein the degree of moisture of the carbon-containing material is between 12% and 28% by weight at the output of the drying of said carbon-containing material.

7. A process according to claim 6, in which the degree of moisture of the carbon-containing material is between 15% and 25% by weight at the output of the drying stage.

8. Process according to claim 1, wherein heat energy is transferred directly or indirectly from the effluent of the POX to the drying stage.

9. A process according to claim 1, in which the flow that is supplied to the POX comprises steam that is generated during the cooling of the effluents of said POX.

10. A process according to claim 1, in which the electrolysis is carried out under a pressure Pe of between 0.5 and 3.5 MPa, and the POX is supplied at a pressure Pₚₒₓ of the formula: 0<Pe−Pₚₒₓ<0.25 MPa.

11. A process according to claim 1, in which the electrolysis is carried out under a pressure Pe of between 0.10 and 0.12 MPa.

12. A process according to claim 8, in which the flow that is supplied to the POX comprises steam that is generated during the cooling of the effluents of said POX.

13. A process according to claim 12, in which the electrolysis is carried out under a pressure Pe of between 0.5 and 3.5 MPa, and the POX is supplied at a pressure Pₚₒₓ of the formula: 0<Pe−Pₚₒₓ<0.15 MPa.

14. A process according to claim 13, in which the electrolysis is carried out under a pressure Pe of between 0.10 and 0.12 MPa.
